(19) United States
(12) Patent Application Publication
(10) Pub. No.: US 2023/0082610 A1
(43) Pub. Date: Mar. 16, 2023

(54) FOLDING CABINET ASSEMBLY

(71) Applicant: Greentouch USA, Inc., Miami, FL (US)

(72) Inventor: Corey Levy, Boulder, CO (US)

(21) Appl. No.: 17/905,317

(22) PCT Filed: Apr. 9, 2021
(86) PCT No.: PCT/US2021/026672

§ 371 Date: Aug. 30, 2022

Related U.S. Application Data
(60) Provisional application No. 63/012,423, filed on Apr. 20, 2020.

(51) Int. Cl. A47B 43/00

(52) U.S. Cl. CPC A47B 43/00

(57) ABSTRACT

A cabinet assembly (10) that is selectively movable between a folded configuration (12) and an expanded configuration (14) includes: a front assembly (16); a first side panel (18); a second side panel (20); and a side hinge assembly (22) that hingeably connects the first side panel (18) to the front assembly (16), and hingeably connects the second side panel (20) to the front assembly (16). The side hinge assembly (22) allows the side panels (18), (20) to pivot relative to the front assembly (16) between (i) the folded configuration (12) in which the side panels (18), (20) are folded relative to the front assembly (16), and (ii) the expanded configuration (14). In the folded configuration (12), the cabinet assembly (10) is relatively easy to ship and store. In the expanded configuration (14), the cabinet assembly (10) is ready for installation and/or use.

### RELATED APPLICATION

This application claims priority on U.S. Provisional Application Ser. No. 63/012,423, filed on Apr. 20, 2020, and entitled “FOLDING CABINET ASSEMBLY”. As far as permitted, the contents of U.S. Provisional Application Ser. No. 63/012,423 are incorporated in their entirety herein by reference.

### BACKGROUND

Cabinets are used in various forms in many places throughout a home or office. For example, cabinets such as in the form of vanities are used in many bathrooms. Additionally, in other implementations, tall cabinets can be used as part of a closet organization system. Further, tower cabinets are also usable in any suitable locations throughout the home or office. There is a never-ending demand to reduce the cost to make, ship and store any and all such cabinets.

### SUMMARY

The present invention is directed toward a cabinet assembly that is selectively movable between a folded configuration and an expanded configuration. In some implementations, the cabinet assembly includes a front assembly, a first side panel, a second side panel, and a side hinge assembly. The side hinge assembly hingeably connects the first side panel to the front assembly, and hingeably connects the second side panel to the front assembly. With this design, the side hinge assembly allows the side panels to pivot relative to the front assembly between (i) the folded configuration in which the side panels are folded relative to the front assembly, and (ii) the expanded configuration in which the cabinet assembly is ready for installation.

With this design, the components of the cabinet assembly can be made and assembled into the folded configuration for ease of shipping and storage. This reduces the cost of shipping and storing of the cabinet assembly. Subsequently, the components of the cabinet assembly can be easily moved to the expanded configuration so that the cabinet assembly is ready for installation, e.g., into and/or adjacent to a structure, and/or use. It is appreciated that the cabinet assembly can be selectively moved to the expanded configuration at the place of installation and/or use.

For example, (i) in the expanded configuration, the first side panel can be spaced apart from and substantially parallel to the second side panel; and (ii) in the folded configuration, the side panels can be substantially parallel to the front assembly. Additionally, or alternatively, (i) in the expanded configuration, the first side panel can be substantially perpendicular to the front assembly, and the second side panel can be substantially perpendicular to the front assembly; and (ii) in the folded configuration, the side panels can be at least partly overlapping.

In certain embodiments, the first side panel pivots relative to the front assembly about a first side panel axis; the second side panel pivots relative to the front assembly about a second side panel axis; and the first side panel axis is closer than the second side panel axis to the front assembly.

In one implementation, the side hinge assembly includes (i) a first side hinge that is coupled to the first side panel; (ii) a first side spacer that couples the first side hinge to the front assembly; (iii) a second side hinge that is coupled to the second side panel; and (iv) a second side spacer that couples the second side hinge to the front assembly. Additionally, in such implementation, the second side spacer can be longer than the first side spacer. In such implementation, when the cabinet assembly is in the folded configuration, the first side panel is closer than the second side panel to the front assembly.

In some embodiments, at least one of the first side panel and the second side panel is rectangular-shaped. In one such embodiment, each of the first side panel and the second side panel is rectangular-shaped.

In one implementation, the cabinet assembly further includes a bottom panel that is movable relative to the side panels. In this design, (i) in the expanded configuration, the bottom panel is substantially perpendicular to the side panels and the front assembly; and (ii) in the folded configuration, the bottom panel is substantially parallel to the side panels and the front assembly. In such implementation, the cabinet assembly can further include a bottom panel hinge assembly that hingeably connects the bottom panel to the front assembly. Additionally, in such implementation, the bottom panel can pivot relative to the front assembly about a bottom panel axis; and the bottom panel axis can be closer to the front assembly than the first side panel axis.

In some embodiments, the front assembly can include a front frame, a door, and a door hinge assembly that pivotably connects the door to the front frame. Additionally, or alternatively, in certain embodiments, the front assembly can include a drawer, and a drawer hinge assembly that pivotably connects the drawer to the front frame.

In certain implementations, when the cabinet assembly is in the expanded configuration the cabinet assembly has a normal form factor, and when the cabinet assembly is in the folded configuration the cabinet assembly has a reduced form factor that is less than approximately fifty percent of the normal form factor. Additionally, in one such implementation, when the cabinet assembly is in the expanded configuration the cabinet assembly has a normal form factor, and when the cabinet assembly is in the folded configuration the cabinet assembly has a reduced form factor that is less than approximately twenty-five percent of the normal form factor.

Additionally, the cabinet assembly can include a countertop and/or a sink that is positioned on top of the front assembly and the side panels.

The present invention is further directed toward a method for forming a cabinet assembly that is selectively movable between a folded configuration and an expanded configuration, including the steps of providing a front assembly; hingeably connecting a first side panel to the front assembly with a side hinge assembly; and hingeably connecting a second side panel to the front assembly with the side hinge assembly; wherein the side hinge assembly allows the side panels to pivot independently relative to the front assembly between (i) the folded configuration in which the side panels are folded relative to the front assembly; and (ii) the expanded configuration for installation.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view of a cabinet assembly in an expanded configuration;

FIG. 2 is a rear perspective view of a portion of the cabinet assembly of FIG. 1 in a partly folded configuration;

FIG. 3 is a front perspective view of a portion of the cabinet assembly of FIG. 1 in the folded configuration;

FIG. 4 is a front perspective view of another implementation of a cabinet assembly in an expanded configuration;

FIG. 5 is a partially exploded front perspective view of the cabinet assembly of FIG. 4 in the expanded configuration;

FIG. 6 is a rear perspective view of a portion of the cabinet assembly of FIG. 4 in a partly folded configuration;

FIG. 7 is a rear perspective view of a portion of the cabinet assembly of FIG. 4 during movement from the folded configuration to the expanded configuration;

FIG. 8A is a rear perspective view of a portion of the cabinet assembly of FIG. 4 during assembly;

FIG. 8B is an enlarged view illustrating a portion of an attachment of a lower rear beam of the cabinet assembly taken within circular cutline B-B in FIG. 8A;

FIG. 8C is another enlarged view illustrating another portion of the attachment of the lower rear beam;

FIG. 9A is a rear perspective view of the cabinet assembly of FIG. 4 during assembly;

FIG. 9B is an enlarged view illustrating a portion of an attachment of a lower rear beam of the cabinet assembly taken within circular cutline B-B in FIG. 9A;

FIG. 9C is another enlarged view illustrating another portion of the attachment of the upper rear beam;

FIG. 10A is a front perspective view of the cabinet assembly of FIG. 4 being secured to a structure;

FIG. 10B is an enlarged view illustrating a portion of an attachment of the upper rear beam taken within circular cutline B-B in FIG. 10A;

FIG. 10C is another enlarged view illustrating the attachment of the upper rear beam;

FIG. 10D is an enlarged view illustrating a threaded foot of the cabinet assembly taken within circular cutline D-D in FIG. 10A;

FIG. 11A is a partly exploded perspective view of the cabinet assembly of FIG. 4 in the expanded configuration;

FIG. 11B is an enlarged view of a portion of FIG. 11A;

FIG. 12A is a perspective view of the cabinet assembly of FIG. 4;

FIGS. 12B-12C are alternative views that illustrate a first adjustment of the cabinet assembly of FIG. 12A;

FIG. 12D is another perspective view of the cabinet assembly of FIG. 4;

FIG. 12E illustrates a second adjustment of the cabinet assembly of FIG. 12D;

FIG. 12F is still another perspective view of the cabinet assembly of FIG. 4;

FIGS. 12G-12H are alternative views that illustrate a third adjustment of the cabinet assembly of FIG. 12F;

FIG. 13 is an illustration of a vanity that incorporates an implementation of the cabinet assembly;

FIG. 14A is a perspective view of a package assembly that is usable to fully retain the cabinet assembly therein when the cabinet assembly is in the folded configuration; and

FIG. 14B is a perspective view of the package assembly of FIG. 14A, with a lid of the package assembly having been removed from a base of the package assembly such that the cabinet assembly in the folded configuration is visible within the base.

### DESCRIPTION

Embodiments of the present invention are described herein in the context of a cabinet assembly that is usable in any suitable locations within a home or office. More particularly, in various embodiments, the cabinet assembly is selectively movable between a folded configuration in which the cabinet assembly has a much smaller form factor so as to effectively reduce the cost to make, ship and store the cabinet assembly, and an expanded configuration in which the cabinet assembly is ready for installation and/or use. Additionally, when the cabinet assembly is in the folded configuration, the cabinet assembly can be easily shipped and/or stored within a package assembly in order to better enable the reduced costs for shipping and storage of the cabinet assembly, while also protecting the integrity and/or condition of the cabinet assembly.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

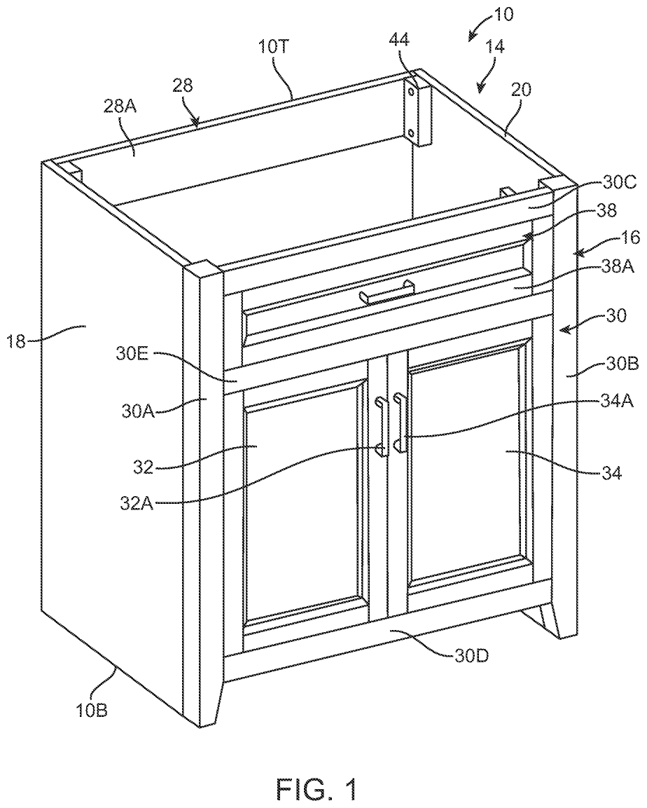

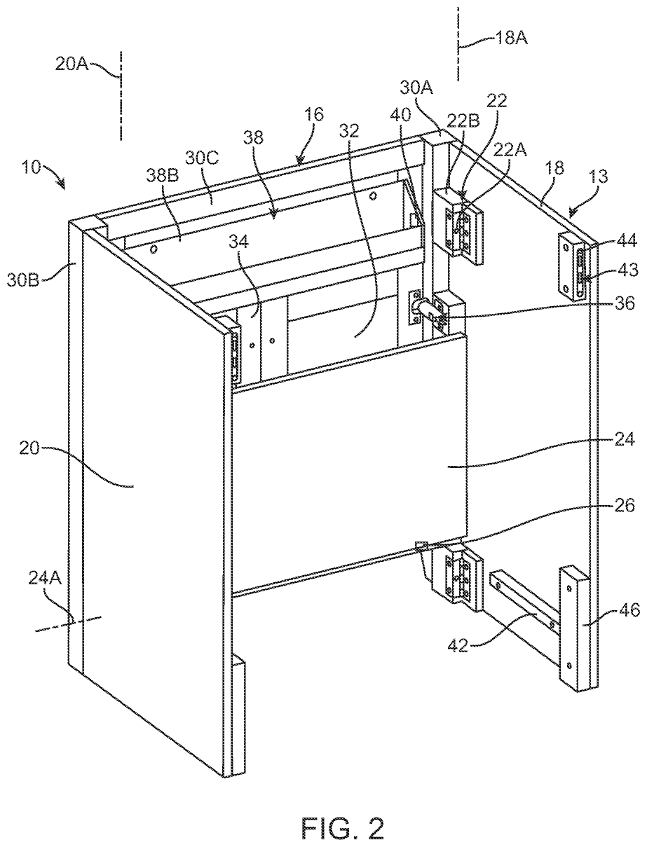

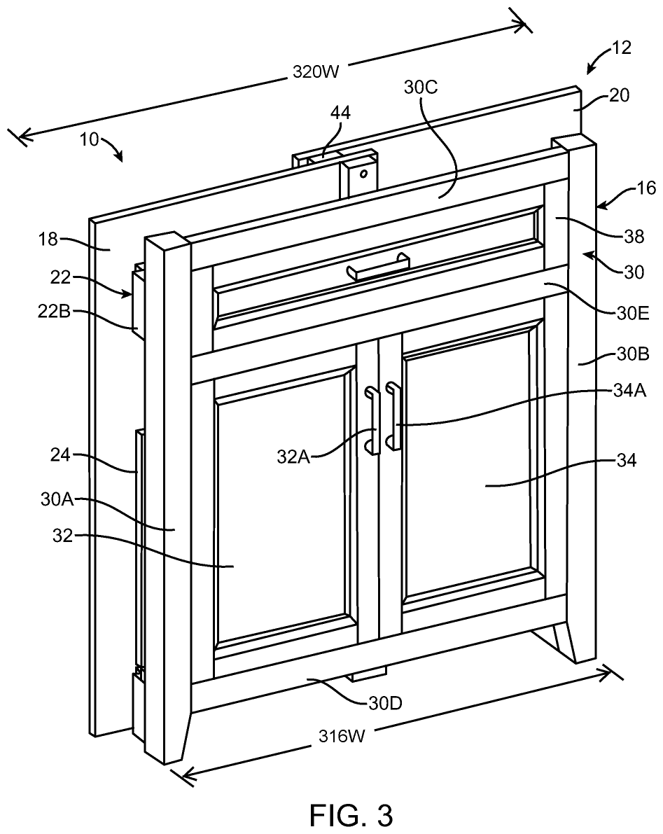

Referring initially to FIGS. 1-3, the present invention is directed to a cabinet assembly 10 that is uniquely designed to be movable between a folded configuration 12 (illustrated in FIG. 3) and an expanded configuration 14 (illustrated in FIG. 1). It is appreciated that any configuration of the cabinet assembly 10 between the folded configuration 12 and the expanded configuration 14 can sometimes be referred to herein as a partly folded configuration 13 (illustrated in FIG. 2). In particular, FIG. 1 is a front perspective view of the cabinet assembly 10 in the expanded configuration 14; FIG. 2 is a rear perspective view of a portion of the cabinet assembly 10 in the partly folded configuration 13, i.e. at a point during movement between the expanded configuration and the folded configuration; and FIG. 3 is a front perspective view of a portion of the cabinet assembly 10 in the folded configuration 12.

As illustrated, when the cabinet assembly 10 is in the expanded configuration 14, the cabinet assembly 10 has a normal form factor and the cabinet assembly 10 is ready for installation and/or use. Conversely, when the cabinet assembly 10 is in the folded configuration 12, the cabinet assembly 10 is folded and has a relatively small, reduced form factor. As non-exclusive examples, the cabinet assembly 10 can be designed to have a reduced form factor in the folded configuration 12 that is less than approximately two-thirds, three-fifths, one-half, two-fifths, one-third, one-fourth or one-fifth of the normal form factor of the cabinet assembly 10 in the expanded configuration 14. Stated in another fashion, the cabinet assembly 10 can be designed to have a reduced form factor in the folded configuration 12 that is less than approximately sixty-seven, sixty, fifty, forty, thirty-three, twenty-five or twenty percent of the normal form factor of the cabinet assembly 10 in the expanded configuration 14. Alternatively, the cabinet assembly 10 can have another suitable reduced form factor when the cabinet assembly 10 is in the folded configuration 12. As utilized herein, the form factor of the cabinet assembly 10 is intended to signify the total volume encompassed by the outer surfaces of the cabinet assembly 10, e.g., width times depth times height in a general rectangular box-like configuration, in whatever configuration the cabinet assembly 10 is in at any given time.

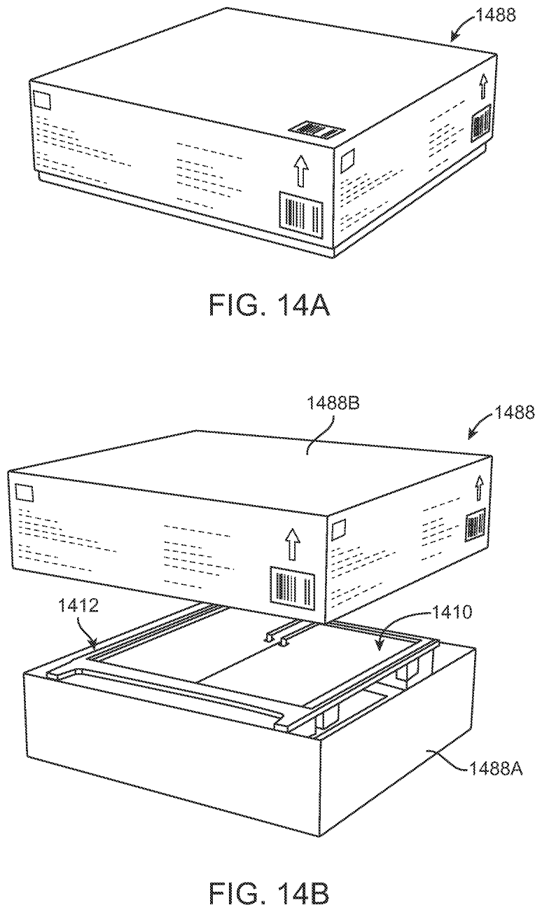

With this design, the components of cabinet assembly 10 can be made and assembled into the folded configuration 12 for ease of shipping and storage. This reduces the cost of shipping and storing of the cabinet assembly 10. For example, as shown in FIG. 14A, the cabinet assembly 10 can be positioned entirely within a package assembly 1488 when the cabinet assembly 10 is in the folded configuration 12 with the reduced form factor. Subsequently, upon removal of the cabinet assembly 10 from the package assembly 1488, the components of the cabinet assembly 10 can be easily moved to the expanded configuration 14 at the place of installation, e.g., such that the cabinet assembly 10 can then be readily installed into and/or adjacent to any suitable structure. Moreover, in certain designs, the cabinet assembly 10 can be moved to the expanded configuration 14 in a tool-free fashion.

The size, shape, and design of the cabinet assembly 10 can be varied to suit specified design requirements of the cabinet assembly and/or to suit the specifications of the user of the cabinet assembly. In one, non-exclusive embodiment, the cabinet assembly 10 is in the form of a bathroom vanity. Alternatively, in another non-exclusive embodiment, the cabinet assembly 10 can be a tall cabinet that can be used as part of a closet organization system. Still alternatively, in still another non-exclusive embodiment, the cabinet assembly 10 can be provided in the form of a tower cabinet that can be usable in any suitable locations throughout a home or office. Yet alternatively, the cabinet assembly 10 could be designed to be another type of cabinet.

As non-exclusive examples, the cabinet assembly 10 can be generally rectangular-shaped and, when in the expanded configuration, can have a width of between approximately twenty-four and forty-eight inches; a height of between approximately twenty-eight and thirty-six inches; and a depth of between approximately eighteen and twenty-four inches. Alternatively, the cabinet assembly 10 can have another suitable shape and/or the width, height and depth of the cabinet assembly 10 can be greater than or less than the specific ranges set forth herein. For example, when the cabinet assembly 10 is provided in the form of a tall cabinet and/or a tower cabinet, the cabinet assembly 10 is likely to have a height that can be much larger than the maximum of thirty-six inches noted herein above. Accordingly, the mention of the potential specific dimensions (i.e. width, height and depth) of the cabinet assembly 10 are not intended to be limiting in any manner, except as otherwise noted herein.

Additionally, in the embodiments described herein, it is appreciated that in movement of the cabinet assembly 10 between the expanded configuration 14 and the folded configuration, the height and the width of the cabinet assembly 10 remain substantially constant, while the depth of the cabinet assembly 10 is reduced when in the folded configuration. Thus, as non-exclusive examples, the cabinet assembly 10 can be designed to have a reduced depth in the folded configuration 12 that is less than approximately two-thirds, three-fifths, one-half, two-fifths, one-third, one-fourth or one-fifth of the normal depth of the cabinet assembly 10 in the expanded configuration 14. Stated in another fashion, the cabinet assembly 10 can be designed to have a reduced depth in the folded configuration 12 that is less than approximately sixty-seven, sixty, fifty, forty, thirty-three, twenty-five or twenty percent of the normal depth of the cabinet assembly 10 in the expanded configuration 14.

In the non-exclusive implementation illustrated in FIGS. 1-3, the cabinet assembly 10 includes (i) a front assembly 16; (ii) a first side panel 18; (iii) a second side panel 20; (iv) a side hinge assembly 22; (v) a bottom panel 24; (vi) a bottom panel hinge assembly 26 (illustrated with a box); and (vii) a rear assembly 28. The design and/or arrangement of these components can be varied pursuant to the teachings provided herein. Additionally or alternatively, the cabinet assembly 10 can be designed to include more components or fewer components than those specifically illustrated in FIGS. 1-3. For example, the cabinet assembly 10 could be designed without the bottom panel hinge assembly 26.

The front assembly 16 forms the front of the cabinet assembly 10. The design of the front assembly 16 can be varied according to the desires of the potential customers. In the non-exclusive implementation of FIGS. 1-3, the front assembly 16 includes a front frame 30, a first door 32, a second door 34, a door hinge assembly 36, a drawer 38, and a drawer hinge assembly 40 (illustrated with a box). Alternatively, for example, the front assembly 16 could be designed with more than two or fewer than two doors, and/or without the drawer and/or the drawer hinge assembly. Further, the design, size and/or shape of the components of the front assembly 16 can be varied.

The front frame 30 can have any suitable design and can be made from any suitable materials. For example, in certain embodiments, the front frame 30 is rigid and can be made of a material such as wood, manufactured wood, particle board or plastic. In one embodiment, as shown in FIG. 1 and FIG. 3, the front frame 30 can be rectangular frame-shaped, and can include a left beam 30A, a right beam 30B, an upper beam 30C, a lower beam 30D, and an intermediate beam 30E. In this design, the left beam 30A and the right beam 30B can be substantially vertically oriented, and the upper beam 30C, the lower beam 30D, and the intermediate beam 30E can extend substantially horizontally between the left beam 30A and the right beam 30B.

The doors 32, 34 can have any suitable design and can be made from any suitable materials. For example, in some embodiments, the first door 32 is rigid and can be made of a material such as wood, manufactured wood, particle board or plastic. The first door 32 can be rectangular-shaped, and can optionally include a handle 32A. Similarly, in certain embodiments, the second door 34 is rigid and can be made of a material such as wood, manufactured wood, particle board or plastic. The second door 34 can also be rectangular-shaped, and can optionally include a handle 34A.

Additionally, as shown in this embodiment, the doors 32, 34 can be coupled to and can be positioned to extend substantially between the left beam 30A and the right beam 30B (i.e. when the doors 32, 34 are closed), and can also be positioned to extend substantially between the lower beam 30D and the intermediate beam 30E.

The door hinge assembly 36 pivotably connects the doors 32, 34 to the front frame 30. As a non-exclusive example, the door hinge assembly 36 can include one or more (e.g., two) door hinges 36A for pivotably coupling each door 32, 34 to the front frame 30.

The drawer 38 provides storage for the cabinet assembly 10. In one embodiment, the drawer 38 includes a rectangular drawer front 38A and box 38B that extends rearwardly away from the back of the drawer front 38A.

In this embodiment, the drawer hinge assembly 40 pivotably connects the drawer 38 to the front frame 30. As a non-exclusive example, the drawer hinge assembly 40 can include one or more (e.g., two) scissor hinges that allow the drawer 38 to selectively tip out. Alternatively, the drawer hinge assembly 40 can have another suitable design and/or the drawer 38 can be configured to move in a different manner relative to the front frame 30. For example, in one such alternative example, the drawer 38 can be configured to simply slide in and out relative to the front frame 30.

The side panels 18, 20 can have any suitable design and can be made from any suitable materials. For example, in certain embodiments, the first side panel 18 is rigid and can be made of a material such as wood, manufactured wood, particle board or plastic. Additionally, the first side panel 18 can be rectangular-shaped. Similarly, in some embodiments, the second side panel 20 is rigid and can be made of a material such as wood, manufactured wood, particle board or plastic. The second side panel 20 can also be rectangular-shaped.

In the Figures provided herein, when looking at the front of the cabinet assembly 10, the left-side panel has been labeled the first side panel 18 and the right-side panel has been labeled the second side panel 20. However, this designation can be reversed.

The side hinge assembly 22 pivotably connects the first side panel 18 to the front assembly 16, and also pivotably connects the second side panel 20 to the front assembly 16. In this embodiment, the side hinge assembly 22 allows the side panels 18, 20 to individually pivot relative to the front assembly 16 as the cabinet assembly 10 is moved between the expanded configuration 14 and the folded configuration 12.

In one non-exclusive implementation, when the cabinet assembly 10 is in the expanded configuration 14, (i) the first side panel 18 is spaced apart from and substantially parallel to the second side panel 20, (ii) the first side panel 18 is substantially perpendicular to the front assembly 16, and (iii) the second side panel 20 is substantially perpendicular to the front assembly 16.

Additionally, in one non-exclusive implementation, when the cabinet assembly 10 is in the folded configuration 12, (i) the side panels 18, 20 are substantially parallel to each other and to the front assembly 16; and (ii) the side panels 18, 20 are at least partly overlapping. Alternatively, in another implementation, the side panels 18, 20 need not be at least partly overlapping when the cabinet assembly 10 is in the folded configuration.

In one implementation, the side hinge assembly 22 can include (i) one or more (e.g., two), first side hinges 22A (shown in FIG. 2) that are coupled to the first side panel 18; (ii) one or more (e.g., two), first side spacers 22B (illustrated in FIG. 2) that couple the first side hinges 22A to the front assembly 16; (iii) one or more (e.g., two), second side hinges (not visible in FIGS. 1-3) that are coupled to the second side panel 20; and (iv) one or more (e.g., two), second side spacers (not visible in FIGS. 1-3) that couple the second side hinges to the front assembly 16. In this non-exclusive design, the side hinges 22A for each side panel 18, 20 are spaced apart from one another with one being positioned near a top 10T of the cabinet assembly 10 and one being positioned near a bottom 10B of the cabinet assembly 10 (e.g., below the bottom panel 24).

With this design, each side panel 18, 20 can pivot independently of the other relative to the front assembly 16. Further, with this design, the first side panel 18 pivots relative to the front assembly 16 about a substantially vertically-oriented, first side panel axis 18A; and (ii) the second side panel 20 pivots relative to the front assembly 16 about a substantially vertically-oriented, second side panel axis 20A. In the embodiment illustrated in FIGS. 1-3, the first side panel axis 18A is substantially parallel to and spaced apart from the second side panel axis 20A. Further, the side panel axes 18A, 20A are substantially parallel to the front assembly 16.

In one implementation, each second side spacer is longer than each first side spacer 22B. As a result thereof, the first side panel axis 18A is closer to the front assembly 16 than is the second side panel axis 20A. Moreover, when the cabinet assembly 10 is in the folded configuration 12, this design allows the side panels 18, 20 to be substantially parallel to each other and to the front assembly 16; and the first side panel 18 to be closer than the second side panel 20 to the front assembly 16.

In one, non-exclusive example, each second side spacer is longer than each first side spacer 22B by a distance that is greater than or equal to a thickness of the first side panel 18 plus the distance of the hinge or fastener thickness.

Alternatively, in another implementation, each second side spacer can be shorter than each first side spacer 22B. As a result thereof, in such alternative implementation, the second side panel axis 20A is closer to the front assembly 16 than is the first side panel axis 18A. Moreover, when the cabinet assembly 10 is in the folded configuration 12, this design allows the side panels 18, 20 to be substantially parallel to each other and to the front assembly 16; and the second side panel 20 to be closer than the first side panel 18 to the front assembly 16.

As noted, in certain embodiments, the side panels 18, 20 can be at least partly overlapping when the cabinet assembly 10 is in the folded configuration 12. However, it is appreciated that depending on the depth of the cabinet assembly 10 (and a corresponding width of the side panels 18, 20) relative to the width of the cabinet assembly 10, and the length of the first side spacers 22B and the second side spacers, the side panels 18, 20 need not be at least partly overlapping when the cabinet assembly 10 is in the folded configuration.

It is further appreciated that for the successful movement of the cabinet assembly 10 between the expanded configuration 14 and the folded configuration 12 with the side hinge assembly 22 as described herein, there are certain limitations on the dimensions, i.e. the width and the depth, of the cabinet assembly 10, as well as the length of the side spacers 22B. In particular, in order for the side panels 18, 20 to be effectively moved to the folded configuration 12 without interfering with the proper operation of the opposing side panels 20, 18, the depth of the cabinet assembly 10 less the length of the shorter side spacer 22B must be less than the width of the cabinet assembly 10. For example, if the depth of the cabinet assembly 10, and thus the width of the first panel 18, less than length of the first side spacer 22B is greater than the width of the cabinet assembly 10, then the movement of the first side panel 18 toward the folded configuration 12 will cause the first panel 18 to directly impact the second side panel 20 before the first side panel 18 is fully moved to the folded configuration 12. With such design, the second side panel 20 would also not be able to be effectively moved to the folded configuration. Thus, it is generally appreciated that the width of the first side panel 18 less the length of the first side spacer 22B must be less than the width of the cabinet assembly 10. However, it is also appreciated that such adverse conditions may also be avoided through the use of a more complicated side hinge assembly 22, e.g., such as having each side panel 18, 20 pivot about two separate substantially vertical axes in the formation of a double-hinge type assembly. Unfortunately, such a double-hinge type assembly may cause other adverse consequences, such as potential adverse effects of the aesthetic appearance of the side panels 18, 20 of the cabinet assembly 10.

The bottom panel 24 can have any suitable design and can be made from any suitable materials. For example, in certain embodiments, the bottom panel 24 is rigid and can be made of a material such as wood, manufactured wood, particle board or plastic. Additionally, the bottom panel 24 can be rectangular-shaped.

The bottom panel 24 provides a floor for the cabinet assembly 10. In one embodiment, when the cabinet assembly 10 is in the expanded configuration 14, the bottom panel 24 is oriented horizontally and is perpendicular to the side panels 18, 20 and the front assembly 16. Additionally, in such embodiment, when the cabinet assembly 10 is in the folded configuration 12, the bottom panel 24 is oriented vertically, is parallel to the side panels 18, 20 and the front assembly 16, and can be positioned between the front assembly 16 and the first side panel 18.

In another embodiment, the bottom panel 24 can include a pair of spaced apart drawer guides (not shown) and a shallow drawer (not shown). In this design, the drawer guides can be secured to an upper surface of the bottom panel 24 and the drawer guides can slidingly connect the shallow drawer to the bottom panel 24. With this design, the shallow drawer can perform the function of a slide out tray. Still alternatively, the shallow drawer can be replaced with a sideless drawer, a drawer with only three sides, or a drawer with only a back panel.

The bottom panel hinge assembly 26 pivotably hinges the bottom panel 24 to the front assembly 16 and allows the bottom panel 24 to pivot relative to the front assembly 16 as the cabinet assembly 10 is moved between the expanded configuration 14 and the folded configuration 12. In one embodiment, the bottom panel hinge assembly 26 includes one or more (e.g., two) hinges. As a result thereof, the bottom panel 24 pivots relative to the front assembly 16 about a bottom panel axis 24A. In certain embodiments, the bottom panel axis 26A is orthogonal to the side panel axes 18A, 20A. Further, in one embodiment, the bottom panel axis 24A can be closer to the front assembly 16 than the first side panel axis 18A and the second side panel axis 20A. With this design, in the folded configuration 12, (i) the bottom panel 24 is substantially parallel to the side panels 18, 20; and (ii) the bottom panel 24 is closer than the first side panel 18 and the second side panel 20 to the front assembly 16.

For all of the embodiments provided herein, it should be noted that the different spacings of the panel axes 18A, 20A, 24A relative to the front assembly 16 allow for the efficient, overlapping stacking of the panels 18, 20, 24 when the cabinet assembly 10 is in the folded configuration 12. However, other spacing of the panel axes 18A, 20A, 24A can be used to change the stacking order of the panels 18, 20, 24 when the cabinet assembly 10 is in the folded configuration 12. For example, the cabinet assembly 10 can be designed so that the first side panel axis 18A is closer to the front assembly 16 than the bottom panel axis 24A so that the first side panel 18 is stacked in front of the bottom panel 24 in the folded configuration 12. Alternatively, the cabinet assembly 10 can be designed so that the first side panel axis 18A is closer to the front assembly 16 than the second side panel axis 20A, and the second side panel axis 20A is closer to the front assembly 16 than the bottom panel axis 24A. This design will result in the order of the stacking of the panels 18, 20, 24 in the folded configuration 12 relative to the front assembly 16 being the first side panel 18, the second side panel 20, and the bottom panel 24.

In one embodiment, a separate support rail 42 (illustrated in FIG. 2) can be attached to each side panel 18, 20 to support the bottom panel 24 in the expanded configuration 14.

The rear assembly 28 is selectively attached at the rear of the cabinet assembly 10, i.e. with an attachment assembly 43 (shown in FIG. 2). In one embodiment, the rear assembly 28 includes an upper rear beam 28A (not shown in FIGS. 2 and 3) that is selectively attached via the attachment assembly 43 to the side panels 18, 20 near a top of the side panels 18, 20, and a lower rear beam (not shown in FIGS. 1-3) that is selectively attached via the attachment assembly 43 to the side panels 18, 20 near a bottom of the side panels 18, 20.

In one embodiment, a separate, upper attachment component 44 can be attached to each side panel 18, 20 via the attachment assembly 43 to selectively retain the upper rear beam 28A, and a separate, lower attachment component 46 can be attached to each side panel 18, 20 via the attachment assembly 43 to selectively retain the lower rear beam.

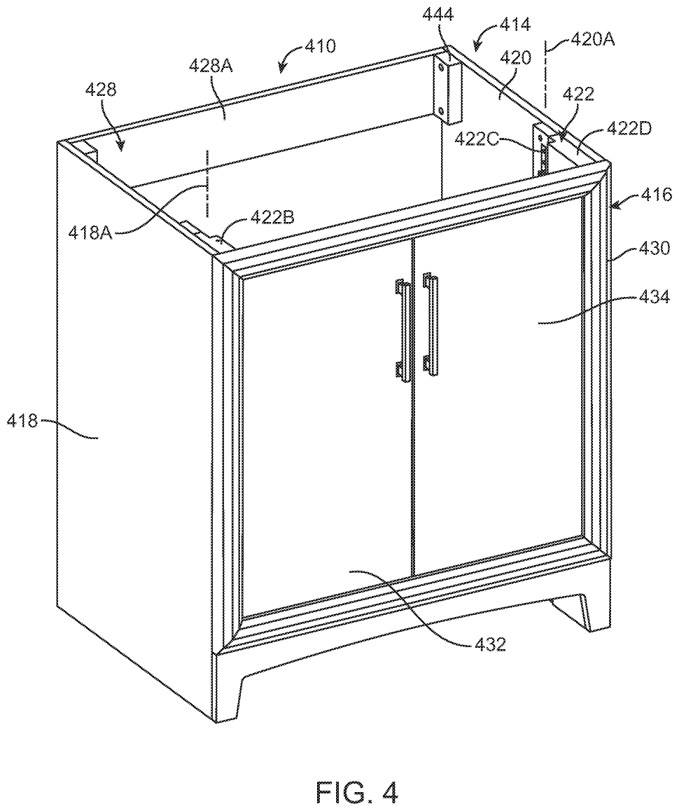

FIGS. 4-12 illustrate another implementation of a cabinet assembly 410 that is somewhat similar to the cabinet assembly 10 described above and illustrated in FIGS. 1-3. For example, the cabinet assembly 410 is again selectively movable between a folded configuration 412 and an expanded configuration 414 in a manner substantially similar to what was illustrated and described herein above. However, in this embodiment, the cabinet assembly 410 does not include a drawer or a corresponding drawer hinge assembly.

More specifically, FIG. 4 is a front perspective view of another implementation of the cabinet assembly 410 shown in the expanded configuration 414. In this Figure, (i) the front assembly 416 including the front frame 430 and doors 432, 434; (ii) the first side panel 418; (iii) the second side panel 420; (iv) the side hinge assembly 422; (v) the upper rear beam 428A of the rear assembly 428; and (vi) the upper attachment components 444, are visible.

In FIG. 4, one of the first spacers 422B, one of the second side hinges 422C, and one of the second spacers 422D of the side hinge assembly 422 are visible.

As provided above, the side hinge assembly 422 allows (i) the first side panel 418 to pivot relative to the front assembly 416 about the first side panel axis 418A; and (ii) the second side panel 420 to pivot relative to the front assembly 416 about the second side panel axis 420A. In the design of FIGS. 4-12, the first side panel axis 418A is substantially parallel to and spaced apart from the second side panel axis 420A. Further, the side panel axes 418A, 420A are substantially parallel to the front assembly 416.

Moreover, in this embodiment, each second side spacer 422D is longer than each first side spacer 422B. As a result thereof, the first side panel axis 418A is closer to the front assembly 416 than the second side panel axis 420A. Further, when the cabinet assembly 410 is in the folded configuration 412, this design allows (i) the side panels 418, 420 to be substantially parallel to each other and to the front assembly 416; and (ii) the first side panel 418 to be closer than the second side panel 420 to the front assembly 416.

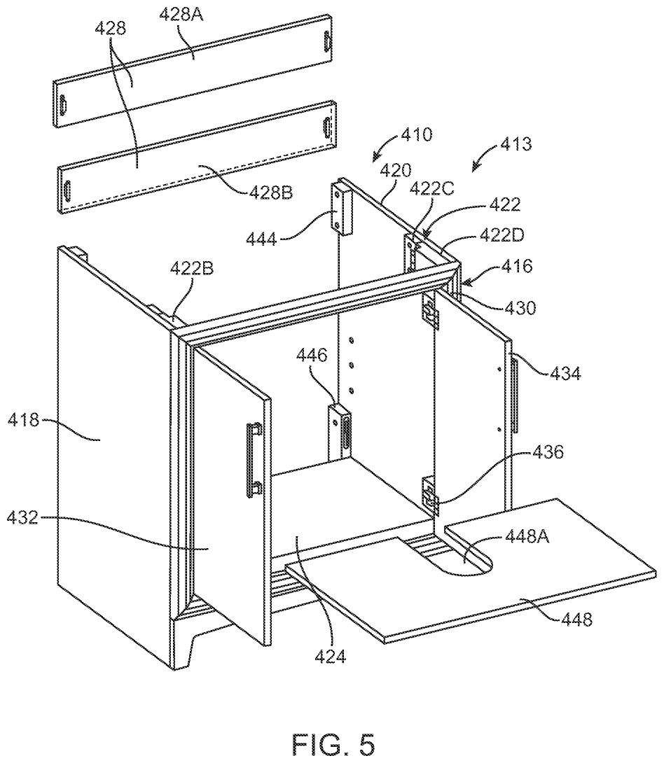

FIG. 5 is a partially exploded front perspective view of the cabinet assembly 410 of FIG. 4 in the expanded configuration 414. In this Figure, (i) the front assembly 416 including the front frame 430 and doors 432, 434; (ii) the first side panel 418; (iii) the second side panel 420; (iv) the side hinge assembly 422 including one of the first spacers 422B, one of the second side hinges 422C, and one of the second spacers 422D; (v) the upper rear beam 428A and the lower rear beam 428B of the rear assembly 428; (vi) some of the upper attachment components 444 and the lower attachment components 446; (vii) the bottom panel 424; (viii) a shelf panel 448 with a cutout 448A; and (ix) a portion of the door hinge assembly 436, are readily visible.

As described in greater detail herein below, the shelf panel 448 can be positioned in alternative positions within the cabinet assembly 410 to provide additional storage options for the user of the cabinet assembly 410.

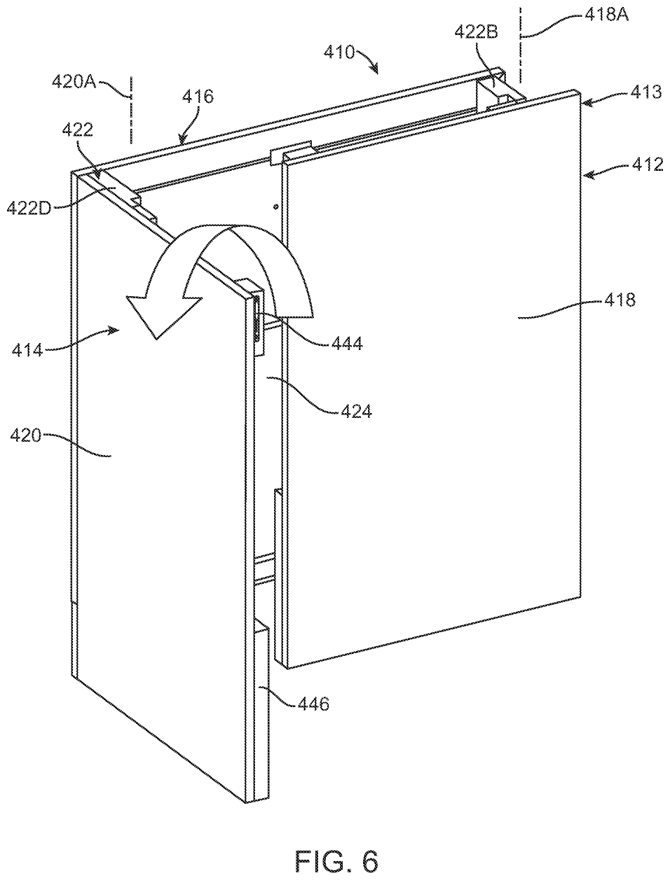

FIG. 6 is a rear perspective view of a portion of the cabinet assembly 410 of FIG. 4 in a partly folded configuration 413, i.e. at a position where the cabinet assembly 410 is in the process of being moved between the folded configuration and the expanded configuration. More particularly, in the specific configuration shown in FIG. 6, the bottom panel 424 and the first side panel 418 are in the folded configuration 412, and the second side panel 420 is in the expanded configuration 414.

In this Figure, (i) the front assembly 416; (ii) the first side panel 418; (iii) the second side panel 420; (iv) the side hinge assembly 422 including one of the first spacers 422B and one of the second spacers 422D; (v) one of the upper attachment components 444 and two of the lower attachment components 446; and (vii) the bottom panel 424, are readily visible. The side panel axes 418A, 420A are also illustrated. In FIG. 6, the second side panel 420 has been rotated about the second side panel axis 420A to the expanded configuration 414, while the first side panel 410 and the bottom panel 424 are still folded into the folded configuration 412.

Again, it is appreciated that, in this embodiment, the first spacers 422B are shorter than the second spacers 422D. As a result thereof, the first side panel axis 418A is closer to the front assembly 416 than the second side panel axis 420A. This will allow the first side panel 418 to fold in front of the second side panel 420, and the side panels 418, 420 can be substantially parallel in the folded configuration 12 (illustrated in FIG. 3). Further, in the illustrated implementation, the first spacers 422B of the first side panel 420 are sized to allow the bottom panel 424 to be folded between the first side panel 420 and the front assembly 416.

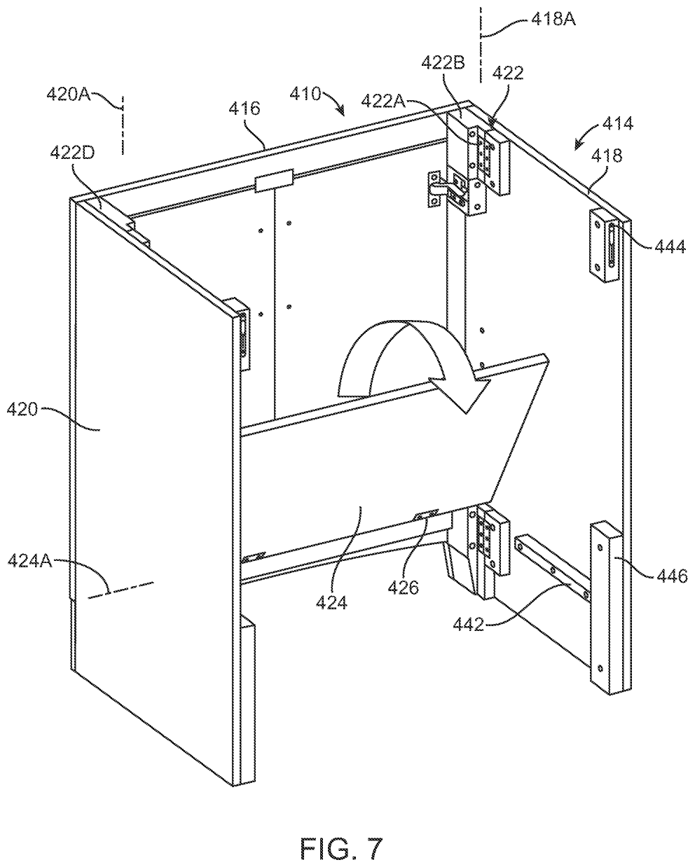

FIG. 7 is a rear perspective view of a portion of the cabinet assembly 410 of FIG. 4 during movement from the folded configuration 412 to the expanded configuration 414. In this Figure, (i) the front assembly 416; (ii) the first side panel 418; (iii) the second side panel 420; (iv) the side hinge assembly 422 including two first side hinges 422A, two first spacers 422B, and one of the second spacers 422D; (v) two of the upper attachment components 444 and two of the lower attachment components 446; (vii) the bottom panel 424, (viii) the bottom hinge assembly 426; and (ix) one support rail 442, are readily visible. The panel axes 418A, 420A, 424A are also illustrated.

Again, it is appreciated that, in this embodiment, the first spacers 422B are shorter than the second spacers 422D, and the first spacers 422B are sized to allow the bottom panel 424 to be folded between the first side panel 420 and the front assembly 416. With this design, the bottom panel axis 424A is the closest to the front assembly 416, and the second panel axis 420A is the farthest to the front assembly 416.

With reference to FIGS. 6 and 7, with the cabinet assembly 410 placed in an upright position, the second side panel 420 is rotated about the second side panel axis 420A and unfolded, i.e. moved toward the expanded configuration 414, first. Next, the first side panel 418 is rotated about the first side panel axis 418A and unfolded toward the expanded configuration 414. Subsequently, the bottom panel 424 is rotated about the bottom panel axis 424A and unfolded toward the expanded configuration 414.

It is appreciated that, as shown in FIG. 7, when the bottom panel 424 is rotated down toward the expanded configuration 414, the bottom panel 424 can be supported by the support rails 442.

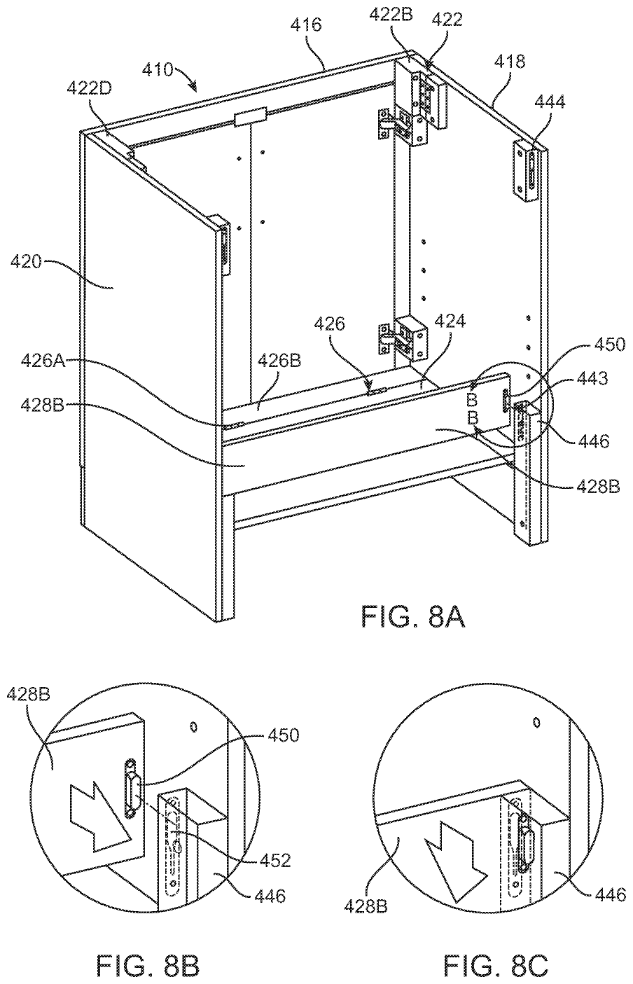

FIG. 8A is a rear perspective view of the cabinet assembly 410 of FIG. 4 during assembly. In this Figure, (i) the front assembly 416; (ii) the first side panel 418; (iii) the second side panel 420; (iv) the side hinge assembly 422; (v) two of the upper attachment components 444 and two of the lower attachment components 446; (vii) the bottom panel 424, (viii) the bottom hinge assembly 426; and (ix) the lower rear beam 428B, are readily visible.

Additionally, as shown, the attachment assembly 443 can be utilized to attach the lower rear beam 428B to the lower attachment component 446 as part of the manner in which the rear assembly 428 is attached to the remainder of the cabinet assembly 410. The attachment assembly 443 can have any suitable design for purposes of attaching the rear assembly 428 to the remainder of the cabinet assembly 410, e.g., for purposes of attaching the lower rear beam 428B to the lower attachment component 446 as shown in FIG. 8A. For example, in this non-exclusive embodiment, the lower rear beam 428B can include one or more pins 450 that can fit and lock into a corresponding slot 452 (illustrated in FIG. 8B) in each lower attachment component 446. With this design, each pin 450 can be inserted into a corresponding slot 452 and the lower rear beam 428B slid down to lock the lower rear beam 428B to the side panels 418, 420. Alternatively, another type of attachment assembly 443 can be used to selectively secure the lower rear beam 428B to the side panels 418, 420.

In certain embodiments, the lower rear beam 428B rests against the upper surface of the bottom panel 424 to assist in holding the bottom panel 424 down.

It should be noted that in this illustrated, non-exclusive embodiment, the bottom hinge assembly 426 includes (i) a pair of spaced apart bottom hinges 426A that are coupled to the bottom panel 424; and (ii) a bottom spacer 426B that couples the bottom hinges 426A to the front assembly 416.

In one implementation, each second side spacer 422D is longer than each first side spacer 422B, and each first side spacer 422B is longer than the bottom spacer 426B. As a result thereof, the bottom panel 424 is closer than the first side panel 418, and the first side panel 418 is closer than the second side panel axis 420 when the cabinet assembly 410 is in the folded configuration. Alternatively, the spacers 422B, 422D, 426B can be sized and shaped for a different, desired folding configuration.

FIG. 8B is an enlarged view that illustrates a portion of the attachment of the lower rear beam 428B taken within circular cutline B-B in FIG. 8A. In particular, FIG. 8B more clearly illustrates that the lower rear beam 428B can include the one or more pins 450 that can fit and lock into the corresponding slot 452 in each lower attachment component 446.

FIG. 8C is another enlarged view illustrating another portion of the attachment of the lower rear beam 428B to the lower attachment component 446.

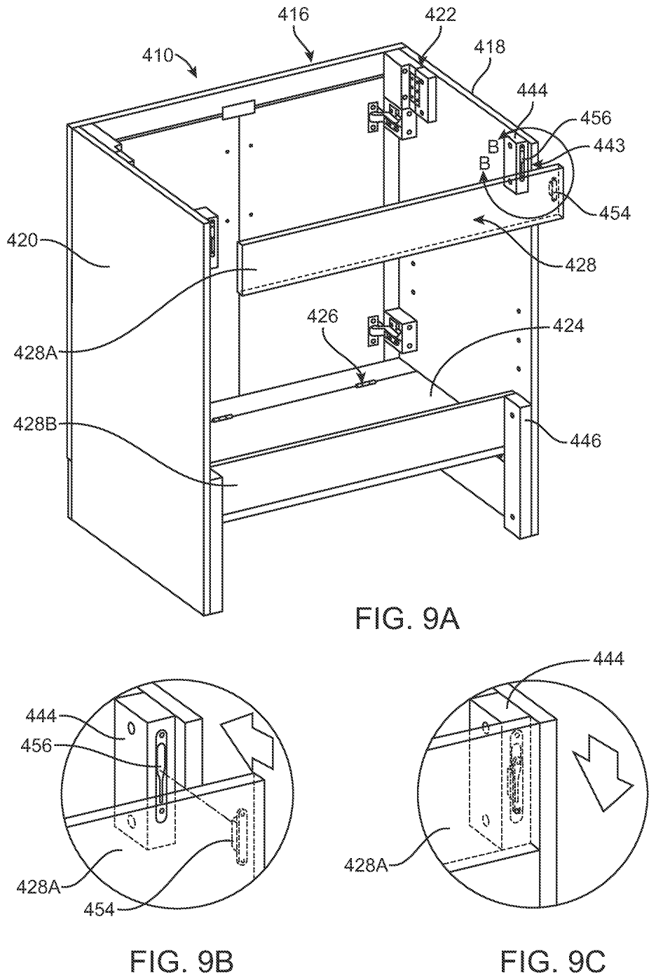

FIG. 9A is another rear perspective view of the cabinet assembly 410 of FIG. 4 during assembly. In this Figure, (i) the front assembly 416; (ii) the first side panel 418; (iii) the second side panel 420; (iv) the side hinge assembly 422; (v) two of the upper attachment components 444 and two of the lower attachment components 446; (vii) the bottom panel 424; (viii) the bottom hinge assembly 426; (ix) the lower rear beam 428B; and (x) the upper rear beam 428A, are readily visible.

Additionally, as shown, the attachment assembly 443 can be utilized to attach the upper rear beam 428A to the upper attachment component 444 as part of the manner in which the rear assembly 428 is attached to the remainder of the cabinet assembly 410. The attachment assembly 443 can have any suitable design for purposes of attaching the upper rear beam 428A to the upper attachment component 444 as shown in FIG. 9A. For example, in this non-exclusive embodiment, the upper rear beam 428A can include one or more pins 454 that can fit and lock into a corresponding slot 456 in each upper attachment component 444. With this design, each pin 454 can be inserted into a corresponding slot 456 and the upper rear beam 428A slid down to lock the upper rear beam 428A to the side panels 418, 420. Alternatively, another type of attachment assembly can be used to selectively secure the upper rear beam 428A to the side panels 418, 420.

In one embodiment, the upper rear beam 428A is secured to a rear surface of each upper attachment component 444, while the lower rear beam 428B is secured to a front surface of each lower attachment component 446.

FIG. 9B is an enlarged view that illustrates a portion of the attachment of the upper rear beam 428A taken within circular cutline B-B in FIG. 9A. In particular, FIG. 9B more clearly illustrates that the upper rear beam 428A can include the one or more pins 454 that can fit and lock into the corresponding slot 456 in each upper attachment component 444.

FIG. 9C is another enlarged view illustrating another portion of the attachment of the upper rear beam 428A to the upper attachment component 444.

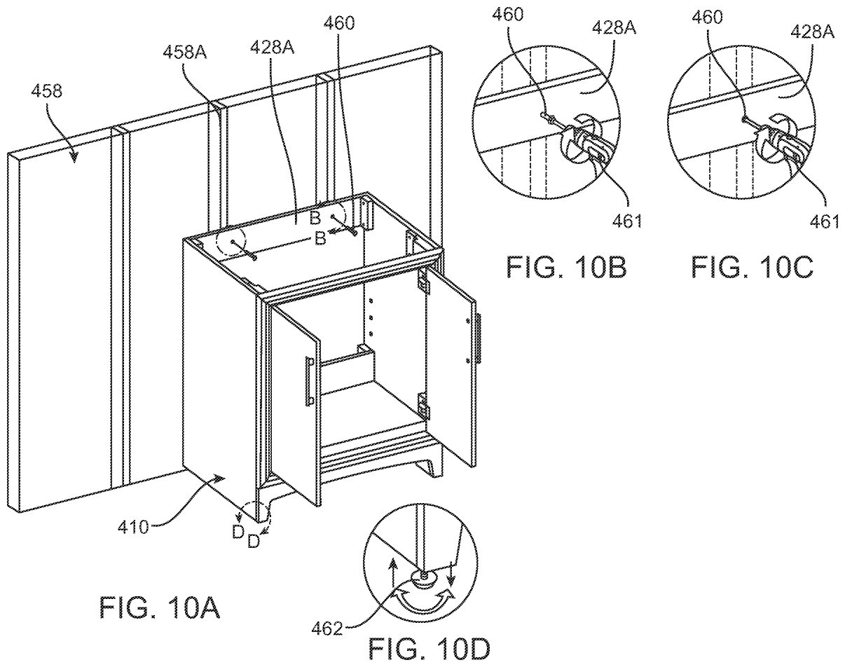

FIG. 10A is a front perspective view of the cabinet assembly 410 of FIG. 4 being secured to a structure 458 (e.g., a wall of a bathroom). In this non-exclusive embodiment, one or more screws 460 (two screws 460 are illustrated in FIG. 10A) can be inserted through the upper rear beam 428A into one or more studs 458A in the structure 458 using a screwdriver 461 (or other suitable tool, illustrated in FIG. 10C). Alternatively, the cabinet assembly 410 can be secured to the structure 458 in another fashion.

FIG. 10B is an enlarged view illustrating a portion of the attachment of the upper rear beam 428A, i.e. by beginning insertion of the screw 460 using the screwdriver 461, taken within circular cutline B-B in FIG. 10A.

FIG. 10C is another enlarged view illustrating completion of the attachment of the upper rear beam 428A, i.e. by finishing insertion of the screw 460 with the screwdriver 461.

Additionally, as shown in FIG. 10D, the cabinet assembly 410 can include one or more threaded feet 462 that can be rotated to selectively adjust the height of the cabinet assembly 410 relative to a support surface, such as a floor. In particular, FIG. 10D is an enlarged view taken within circular cutline D-D in FIG. 10D that illustrates one of the threaded feet 462.

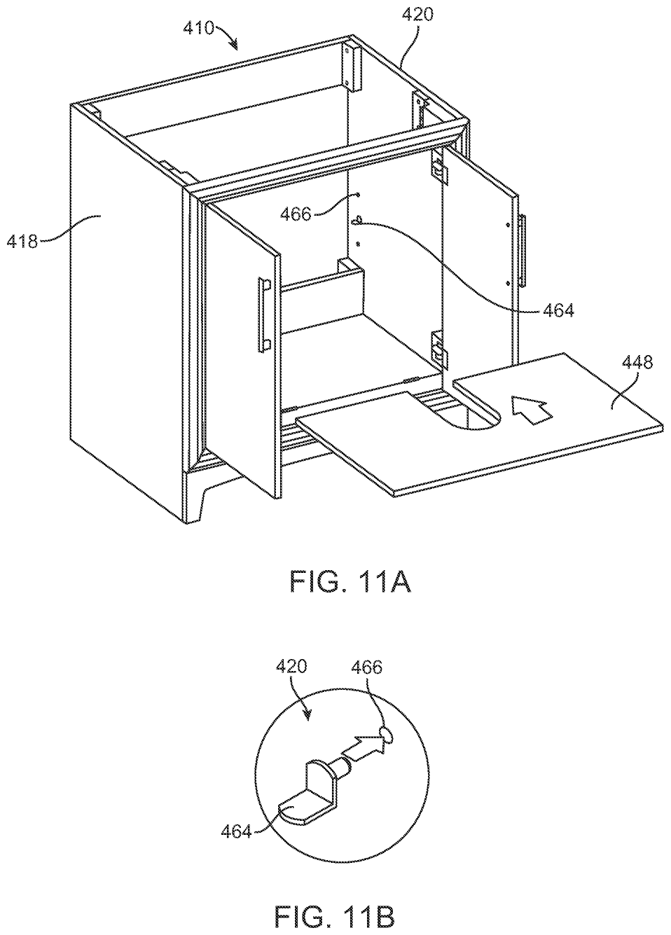

FIG. 11A is a partially exploded perspective view of the cabinet assembly 410 of FIG. 4 during installation of the shelf panel 448. Further, FIG. 11B is an enlarged view of a portion of a means in which the shelf panel 448 can be positioned as desired within the cabinet assembly 410. In this non-exclusive embodiment, one or more shelf pins 464 can be inserted into corresponding apertures 466 in the side panels 418, 420. Subsequently, the shelf panel 448 can be positioned to rest on the inserted shelf pins 464. Alternatively, the shelf panel 448 can be retained in a different fashion

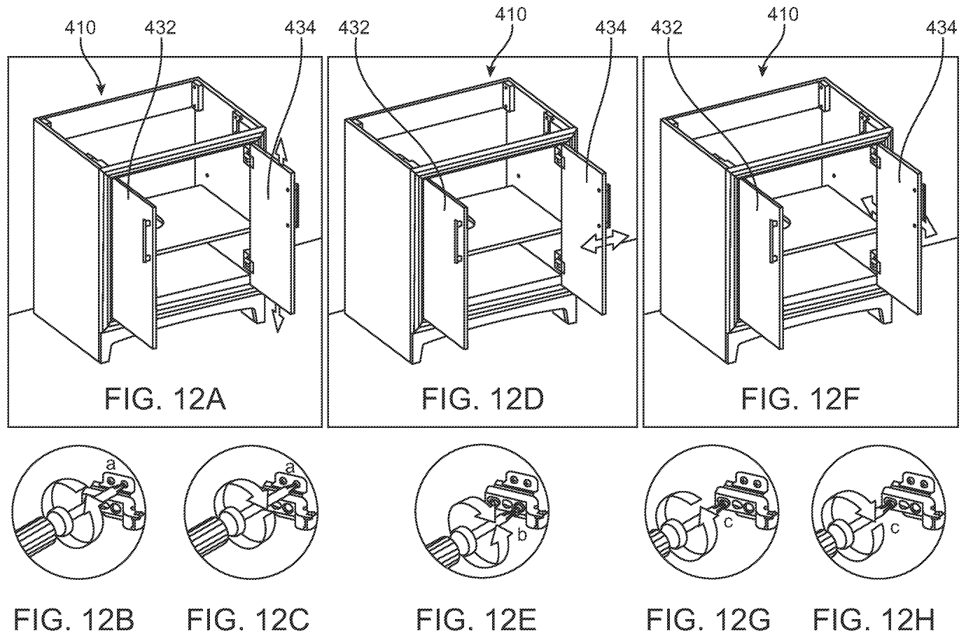

FIGS. 12A-12H illustrate three alternative views of the cabinet assembly 410 that illustrate three individual adjustments of the doors 432, 434 of the cabinet assembly 410.

For a first adjustment, FIG. 12A is a perspective view of the cabinet assembly 410 of FIG. 4, including doors 432, 434. FIGS. 12B-12C are alternative views that illustrate the first adjustment of the cabinet assembly of FIG. 12A. In particular, to adjust the doors 432, 434 up or down, loosen screws labeled “a” on both hinges, adjust the door 432, 434, and retighten the screws.

For a second adjustment, FIG. 12D is a perspective view of the cabinet assembly 410 of FIG. 4, including doors 432, 434. FIG. 12E is a view that illustrates the second adjustment of the cabinet assembly of FIG. 12D. In particular, to adjust the doors 432, 434 left or right, turn screws labeled “b” on both hinges, in or out.

For a third adjustment, FIG. 12F is a perspective view of the cabinet assembly 410 of FIG. 4, including doors 432, 434. FIGS. 12G-12H are alternative views that illustrate the third adjustment of the cabinet assembly of FIG. 12F. In particular, to adjust the doors 432, 434 in or out, loosen screws labeled “c” on both hinges, and retighten the screws.

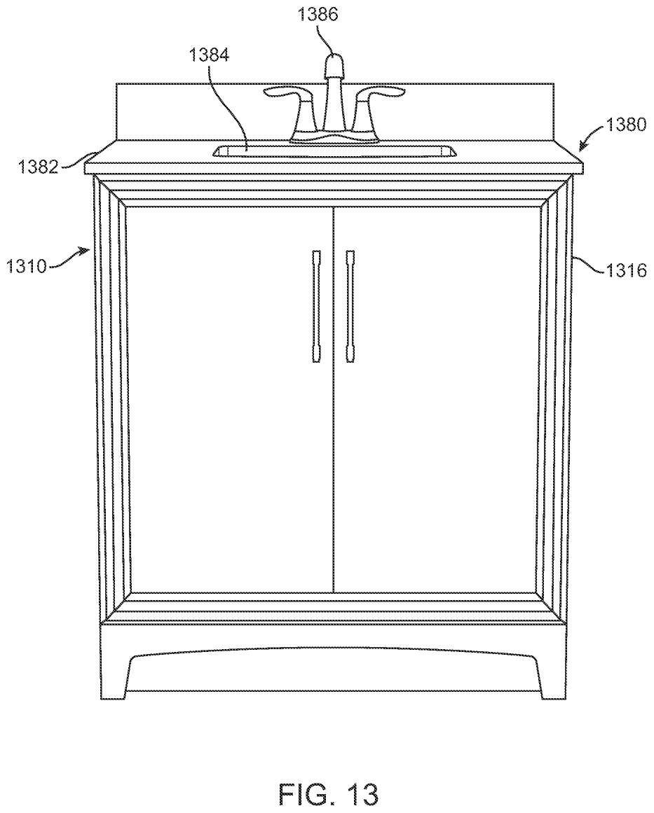

FIG. 13 is an illustration of a vanity 1380 that includes a foldable cabinet assembly 1310, with a countertop 1382, a sink 1384, and a faucet assembly 1386. In this implementation, the countertop 1382 and the sink 1384 are positioned on top of the front assembly 1316 and the side panels.

FIG. 14A is a perspective view of a package assembly 1488 that is usable to fully retain the cabinet assembly 1410 (illustrated in FIG. 14B) therein when the cabinet assembly 1410 is in the folded configuration 1412 (illustrated in FIG. 14B). With the cabinet assembly 1410 in the folded configuration 1412, the package assembly 1488 is able to retain the desired more compact, reduced form factor for the cabinet assembly 1410, which reduces the cost of shipping and storing of the cabinet assembly 1410.

FIG. 14B is a perspective view of the package assembly 1488 of FIG. 14A. In particular, as shown, the cabinet assembly 1410 is in the folded configuration 1412 and is visible within a base 1488A of the package assembly 1488. Additionally, as shown, the package assembly 1488 has been opened, with a lid 1488B of the package assembly 1488 having been moved and/or removed relative to the base 1488A, such that the cabinet assembly 1410 in the folded configuration 1412 is visible within the base 1488A.

As shown, in certain embodiments, the package assembly 1488 can have a package form factor that is substantially equal to, or is only slightly larger than, the reduced form factor of the cabinet assembly 1410 in the folded configuration 1412. As utilized herein, the statement that the package assembly 1488 has a package form factor that is substantially equal to, or is only slightly larger than, the reduced form factor of the cabinet assembly 1410 in the folded configuration 1412, includes only limited variations for the thickness of the materials used for the package assembly 1488 as well as the size of any secure packaging materials that may be packed around the cabinet assembly 1410 to protect the cabinet assembly 1410 from damage during shipping and storage.

It is further appreciated that when the cabinet assembly 1410 is fully removed from the package assembly 1488, the cabinet assembly 1410, which would still be in the folded configuration 1412 at that point, would have an appearance such as shown for the cabinet assembly 10 as illustrated in FIG. 3.

It is understood that although a number of different embodiments of the cabinet assembly 10 have been illustrated and described herein, one or more features of any one embodiment can be combined with one or more features of one or more of the other embodiments, provided that such combination satisfies the intent of the present invention.

While a number of exemplary aspects and embodiments of the cabinet assembly 10 have been shown and disclosed herein above, those of skill in the art will recognize certain modifications, permutations, additions and sub-combinations thereof. It is therefore intended that the cabinet assembly 10 shall be interpreted to include all such modifications, permutations, additions and sub-combinations as are within their true spirit and scope, and no limitations are intended to the details of construction or design herein shown.

1-38. (canceled)

39. A cabinet assembly that is selectively movable between a folded configuration and an expanded configuration, the cabinet assembly comprising:
a front assembly;
a first side panel;
a second side panel; and
a side hinge assembly that hingeably connects the first side panel and the second side panel to the front assembly, and allows the side panels to pivot independently relative to the front assembly as the cabinet assembly is moved between the folded configuration in which the side panels are folded relative to the front assembly, and the expanded configuration in which the cabinet is configured for installation; the side hinge assembly including (i) a first side spacer that is fixedly coupled to the front assembly, (ii) a first side hinge that is coupled to the first side spacer and the first side panel such that the first side hinge is spaced apart from the front assembly and so that the first side panel is pivotable relative to the first side spacer as the cabinet assembly is moved between the folded configuration and the expanded configuration, (iii) a second side spacer that is fixedly coupled to the front assembly, and (iv) a second side hinge that is coupled to the second side spacer and the second side panel such that the second side hinge is spaced apart from the front assembly and so that the second side panel is pivotable relative to the second side spacer as the cabinet assembly is moved between the folded configuration and the expanded configuration; and
wherein the second side spacer is longer than the first side spacer such that the second side hinge is spaced further than the first side hinge from the front assembly.

40. The cabinet assembly of claim 39 wherein the front assembly has an assembly width; wherein the first side panel and the second side panel cooperate to have a panel width when the cabinet assembly is in the folded configuration; and wherein the panel width is greater than the assembly width.

41. The cabinet assembly of claim 39 wherein (i) when the cabinet assembly is in the expanded configuration, the first side panel is substantially perpendicular to the front assembly, and the second side panel is substantially perpendicular to the front assembly; and (ii) when the cabinet assembly is in the folded configuration, the side panels are substantially parallel to the front assembly.

42. The cabinet assembly of claim 39 wherein when the cabinet assembly is in the folded configuration, the first side panel is closer than the second side panel to the front assembly.

43. The cabinet assembly of claim 39 wherein when the cabinet assembly is in the folded configuration, the side panels are at least partly overlapping.

44. The cabinet assembly of claim 39 further comprising a bottom panel that is movable relative to the side panels; wherein (i) when the cabinet assembly is in the expanded configuration, the bottom panel is substantially perpendicular to the side panels and the front assembly; and (ii) when the cabinet assembly is in the folded configuration, the bottom panel is substantially parallel to the side panels and the front assembly.

45. The cabinet assembly of claim 44 further comprising a bottom panel hinge assembly that hingeably connects the bottom panel to the front assembly; wherein the bottom panel pivots relative to the front assembly about a bottom panel axis.

46. The cabinet assembly of claim 45 (i) wherein the first side panel pivots relative to the front assembly about a first side panel axis; (ii) wherein the second side panel pivots relative to the front assembly about a second side panel axis; (iii) wherein the first side panel axis is closer than the second side panel axis to the front assembly; and (iv) wherein the bottom panel axis is closer to the front assembly than the first side panel axis.

47. The cabinet assembly of any one of claim 39 wherein when the cabinet assembly is in the expanded configuration the cabinet assembly has a normal form factor; and wherein when the cabinet assembly is in the folded configuration the cabinet assembly has a reduced form factor that is less than approximately fifty percent of the normal form factor.

48. The cabinet assembly of claim 39 further comprising one of a countertop and a sink that is positioned on top of the front assembly and the side panels.

49. A method for forming a cabinet assembly that is selectively movable between a folded configuration and an expanded configuration, the method comprising the steps of:
providing a front assembly;
hingeably connecting a first side panel to the front assembly with a side hinge assembly; and
hingeably connecting a second side panel to the front assembly with the side hinge assembly;
wherein the side hinge assembly allows the side panels to pivot independently relative to the front assembly as the cabinet assembly is moved between the folded configuration in which the side panels are folded relative to the front assembly, and the expanded configuration in which the cabinet is configured for installation;
wherein the side hinge assembly includes (i) a first side spacer that is fixedly coupled to the front assembly, (ii) a first side hinge that is coupled to the first side spacer and the first side panel such that the first side hinge is spaced apart from the front assembly and so that the first side panel is pivotable relative to the first side spacer as the cabinet assembly is moved between the folded configuration and the expanded configuration, (iii) a second side spacer that is fixedly coupled to the front assembly, and (iv) a second side hinge that is coupled to the second side spacer and the second side panel such that the second side hinge is spaced apart from the front assembly and so that the second side panel is pivotable relative to the second side spacer as the cabinet assembly is moved between the folded configuration and the expanded configuration; and
wherein the second side spacer is longer than the first side spacer such that the second side hinge is spaced further than the first side hinge from the front assembly.

50. The method of claim 49 wherein the front assembly has an assembly width; wherein the first side panel and the second side panel cooperate to have a panel width when the cabinet assembly in the folded configuration; and wherein the panel width is greater than the assembly width.

51. The method of claim 49 wherein (i) when the cabinet assembly is in the expanded configuration, the first side panel is substantially perpendicular to the front assembly, and the second side panel is substantially perpendicular to the front assembly; and (ii) when the cabinet assembly is in the folded configuration, the side panels are substantially parallel to the front assembly.

52. The method of claim 49 wherein when the cabinet assembly is in the folded configuration, the first side panel is closer than the second side panel to the front assembly.

53. The method of claim 49 wherein when the cabinet assembly is in the folded configuration, the side panels are at least partly overlapping.

54. The method of claim 49 further comprising the step of hingeably connecting the bottom panel to the front assembly with a bottom panel hinge assembly so that the bottom panel is movable relative to the side panels; wherein the bottom panel pivots relative to the front assembly about a bottom panel axis; and wherein (i) when the cabinet assembly is in the expanded configuration, the bottom panel is substantially perpendicular to the side panels and the front assembly; and (ii) when the cabinet assembly is in the folded configuration, the bottom panel is substantially parallel to the side panels and the front assembly.

55. The method of claim 54 wherein the step of hingeably connecting the first side panel includes the first side panel pivoting relative to the front assembly about a first side panel axis; wherein the step of hingeably connecting the second side panel includes the second side panel pivoting relative to the front assembly about a second side panel axis; wherein the first side panel axis is closer than the second side panel axis to the front assembly; and wherein the bottom panel axis is closer to the front assembly than the first side panel axis.

56. The method of claim 49 wherein when the cabinet assembly is in the expanded configuration the cabinet assembly has a normal form factor; and wherein when the cabinet assembly is in the folded configuration the cabinet assembly has a reduced form factor that is less than approximately fifty percent of the normal form factor.

57. The method of claim 49 further comprising the step of positioning one of a countertop and a sink on top of the front assembly and the side panels.

58. A cabinet assembly that is selectively movable between a folded configuration and an expanded configuration, the cabinet assembly comprising:
a front assembly that has an assembly width;
a first side panel;
a second side panel;
a side hinge assembly that hingeably connects the first side panel and the second side panel to the front assembly, and allows the side panels to pivot independently relative to the front assembly as the cabinet assembly is moved between the folded configuration in which the side panels are folded relative to the front assembly, and the expanded configuration in which the cabinet is configured for installation; the side hinge assembly including (i) a first side spacer that is fixedly coupled to the front assembly, (ii) a first side hinge that is coupled to the first side spacer and the first side panel such that the first side hinge is spaced apart from the front assembly and so that the first side panel is pivotable relative to the first side spacer as the cabinet assembly is moved between the folded configuration and the expanded configuration, (iii) a second side spacer that is fixedly coupled to the front assembly, and (iv) a second side hinge that is coupled to the second side spacer and the second side panel such that the second side hinge is spaced apart from the front assembly and so that the second side panel is pivotable relative to the second side spacer as the cabinet assembly is moved between the folded configuration and the expanded configuration;
a bottom panel that is movable relative to the side panels; and
a bottom panel hinge assembly that hingeably connects the bottom panel to the front assembly;
wherein the second side spacer is longer than the first side spacer such that the second side hinge is spaced further than the first side hinge from the front assembly;
wherein when the cabinet assembly is in the expanded configuration, the first side panel is substantially perpendicular to the front assembly, the second side panel is substantially perpendicular to the front assembly, and the bottom panel is substantially perpendicular to the side panels and the front assembly;
wherein when the cabinet assembly is in the folded configuration, the side panels are substantially parallel to the front assembly, the first side panel is closer than the second side panel to the front assembly, and the bottom panel is substantially parallel to the side panels and the front assembly;
wherein the first side panel pivots relative to the front assembly about a first side panel axis, the second side panel pivots relative to the front assembly about a second side panel axis, and the bottom panel pivots relative to the front assembly about a bottom panel axis;
wherein the first side panel axis is closer than the second side panel axis to the front assembly, and the bottom panel axis is closer to the front assembly than the first side panel axis;
wherein the first side panel and the second side panel cooperate to have a panel width when the cabinet assembly in the folded configuration; and
wherein the panel width is greater than the assembly width.
